(19) United States
(12) Patent Application Publication
(10) Pub. No.: US 2020/0270912 A1
(43) Pub. Date: Aug. 27, 2020

(54) MOTOR VEHICLE WITH DOOR LOCKS AND CONTROL UNIT

(71) Applicant: Kiekert AG, Heiligenhaus (DE)

(72) Inventor: Holger SCHIFFER, Meerbusch (DE)

(21) Appl. No.: 16/757,515

(22) PCT Filed: Oct. 18, 2018
(86) PCT No.: PCT/DE2018/100858

§ 371 Date: May 13, 2020

(30) Foreign Application Priority Data
Oct. 20, 2017 (DE) 10 2017 124 527.8

(51) Int. Cl. E05B 77/26; B60R 25/01; B60R 25/24; B60R 25/23; E05B 81/16; E05B 81/72; E05B 77/48; E05B 81/64; E05B 77/24

(52) U.S. Cl. CPC E05B 77/26; B60R 25/01; B60R 25/24; B60R 25/23; E05Y 2900/531; E05B 81/72; E05B 77/48; E05B 81/64; E05B 77/245; E05B 81/16

(57) ABSTRACT

A motor vehicle, which is equipped with a plurality of motor vehicle door locks and at least one control unit. Each motor vehicle door lock has at least one actuating lever chain acting mechanically on a locking mechanism. The status of the actuating lever chain (active/inactive) is detected with the aid of a sensor and sent to the control unit. The control unit differentiates between individual function positions depending on the door lock-specific status of the actuating lever chain.

The invention relates to a motor vehicle comprising a plurality of motor vehicle door latches, as well as at least one control unit, each motor vehicle door latch comprising at least one operating lever chain that acts mechanically on a locking mechanism, the relevant status (active/inactive) of which chain is determined using a sensor and transmitted to the control unit.

Modern motor vehicles are often equipped with four motor vehicle door latches, on associated side doors. For example, the two front and the two rear side doors each comprise a motor vehicle door latch. In addition, further motor vehicle door latches are generally implemented, for example a motor vehicle door latch on or in a front hood, as well as a further motor vehicle door latch which is associated with a tailgate. Of course, further motor vehicle door latches can also be implemented, which are used for locking covers such as an engine cover, a petrol cap cover, etc.

Whereas hood latches or hatch latches in general know only the state “latched” or “unlatched” or open, further functional positions are distinguished with reference to the side doors. These include for example the “theft-proof” position, in which the side door in question can be opened neither from the outside nor from the inside. This is to be distinguished from the “childproof” functional position, which is required only on the rear side doors, and allows for opening from the outside but prevents opening from the inside. As a result, the associated side door locks are usually designed and constructed differently. This is fundamentally disadvantageous within the context of simplified manufacturing and assembly, as well as implementation.

A motor vehicle door latch system is described in the generic prior art according to DE 102 59 972 A1. Said system comprises a child safety lock, and electrical internal operating means. The child safety lock can be requested by means of a sensor. An additional control unit activates or deactivates the electrical internal operation, depending on the signal of said sensor.

Furthermore, a central locking system is known from DE 195 30 720 A1, by the applicant. Said system makes use of various control units. At this point it is important in particular to identify non-family components, for example.

Finally, DE 10 2004 036 670 A1 discloses a motor vehicle latch comprising a motorized opening drive. Furthermore, an operating mechanism or operating lever chain is implemented, for mechanical operation of the closing elements from the outside and from the inside, by means of an external operating element and an internal operating element. The possibility of unifying the individual motor vehicle door latches is not addressed.

The invention addresses the technical problem of developing a motor vehicle of the type in question, comprising a plurality of motor vehicle door latches and at least one control unit, such that the motor vehicle door latches are formed as uniformly as possible, and that all conventional functional positions can nonetheless be reproduced.

In order to solve this technical problem, a motor vehicle of the type in question is characterized, within the context of the invention, in that the control unit distinguishes between individual functional positions, depending on the door latch-specific status of the operating lever chain.

According to an advantageous embodiment, the operating lever chain is generally formed as an internal operating lever chain. In contrast, an external operating lever chain is generally lacking. For this reason, the external operation typically takes place by means of an electromotive opening drive. For this purpose, the electromotive opening drive is acted on only in the event of external operation of an associated motor vehicle door.

In this case, the external operation itself can generally be achieved by means of remote control and/or keylessly by means of a question/answer dialog, and/or by means of a sensory query of an outer door handle. In contrast, the operating lever chain or internal operating lever chain is generally acted on using an inner door handle.

The operating lever chain or internal operating lever chain usually comprises a coupling that can be acted on electromotively. In this way, the relevant status can be achieved. If, for example, the operating lever chain in question, of the motor vehicle door latch considered, is in the “active” position, then, in the case given by way of example, action by means of the inner door handle results in the closed operating lever chain or internal operating lever chain being able to act on the locking mechanism and raise it. The associated motor vehicle door can consequently be opened from the inside. The coupling is inserted. By means of the sensor, the position of the coupling, and consequently of the operating lever chain, can be retrieved and transmitted to a control unit.

In contrast, the “inactive” status corresponds to the coupling being disengaged. The operating lever chain or internal operating lever chain is mechanically interrupted. Action by means of the inner door handle therefore comes to nothing, with respect to the locking mechanism. The locking mechanism therefore cannot be opened.

The electromotive drive for the coupling now makes it possible for functional states to be achieved on the relevant motor vehicle door latch and thus on the associated motor vehicle door, such as “locked inside” or “unlocked inside.” The “locked inside” position corresponds to the disengaged coupling, and therefore to the internal operating lever chain being interrupted, and action on the inner door handle coming to nothing. In contrast, the locking mechanism can be opened in the “unlocked inside” position.

In addition to these functional positions, however, more extensive functions can also be achieved and reproduced. Thus, for example, the “theft-proof” functional position corresponds to the electromotive opening drive being just as inactive as the inner door handle for external operation. That is to say that the associated motor vehicle cannot be opened or unlocked, either by action on the inner door handle or by action on the outer door handle.

According to the invention, a “child safety lock” can also be achieved in this manner. In this case it is important in particular to evaluate the door latch-specific status of the operating lever chain and to transmit this to the control unit or to carry this out by means of the control unit. In this connection, the door latch-specific status of the operating lever chain does not only contain information about the status of the operating lever chain in the sense of “active/inactive,” as is delivered by the sensor of the associated motor vehicle door latch. Instead, the door latch-specific status of the operating lever chain also provides the control unit with information on the associated motor vehicle door latch per se.

This can be achieved for example in that, when four motor vehicle door latches are formed on the associated four side doors, the individual sensor signals are different, with the result that the control unit at the same time receives information, from the sensor signal, regarding the motor vehicle door latch from which the original sensor signal originates. Alternatively thereto, it is of course also possible, however, for the control unit to call up the motor vehicle door latch in question by means of a bus system that is usually in any case provided, and to ultimately be informed, via the bus address associated with the motor vehicle door latch, and the output sensor signal, of the door latch-specific status of the operating lever chain in the relevant motor vehicle door latch, and to optionally also be able to implement said status.

In this manner, the door latch-specific status conveys information about the spatial/functional design of the relevant motor vehicle door latch. For example, the door latch-specific status reveals that the operating lever chain of the left-hand rear motor vehicle door latch in the motor vehicle body has the status “active.” In this manner, the control unit can actuate some or all of the motor vehicle door latches in a door latch-specific manner, depending on the functional position that is desired and is to be implemented.

If, for example, the “childproof” functional position is to be implemented, the control unit ensures that the electromotive drives, of the associated motor vehicle door latches, that in each case act directly on the locking mechanism, continue to be active. That is to say that all the motor vehicle doors can be unlocked and electrically opened from the outside. At the same time, as a result of the desired “childproof” functional position, with respect to the two rear side doors and the motor vehicle door latches provided there the coupling is acted on by means of the electromotive drive, such that the associated internal operating lever chain assumes the “inactive” status. As a result, the action of the inner door handle on the two rear side doors comes to nothing, as is expected in the associated “child safety lock on” position.

In contrast, the electromotive drives for the relevant coupling of the associated operating lever chain in the motor vehicle door latches of the two front side doors are for example not actuated, or the internal operating lever chain retains its “active” status. Thus, as soon as the inner door handle of the relevant associated front side door is acted upon, the front side door can be opened as desired, but the relevant rear side door cannot be.

In this way, overall a motor vehicle equipped with a plurality of motor vehicle door latches is provided, in which the individual motor vehicle door latches are virtually identical, in structure, for all the side doors. The different functional positions are distinguished by the control unit, or in that the status of the operating lever chain is called up, in particular in a door latch-specific manner. As a result, the control unit can actuate the motor vehicle door latches in different ways, and can reproduce and implement different states. This is all achieved taking account of a remarkably simple and functionally reliable design. This has substantial advantages.

In the following, the invention will be explained in greater detail with reference to drawings showing merely one exemplary embodiment, in which drawings:

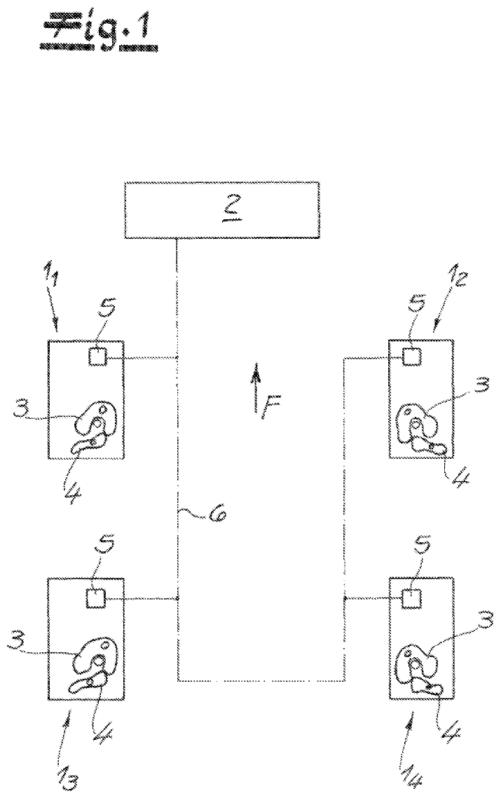

FIG. 1 is a schematic view of the motor vehicle according to the invention motor vehicle, and

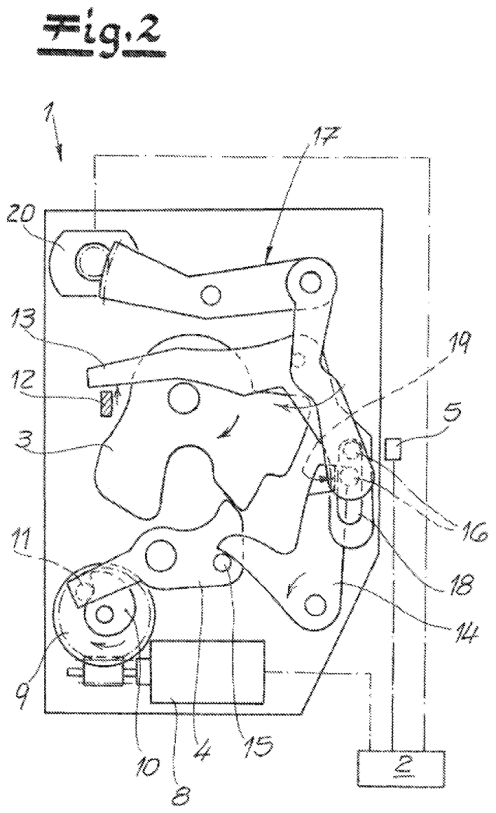

FIG. 2 is an overall view of an associated motor vehicle door latch.

FIG. 1 shows a motor vehicle which is equipped with a plurality of motor vehicle door latches 1 and at least one control unit 2. The individual motor vehicle door latches 1 are associated with front and rear side doors which are not shown explicitly. The schematic drawing in FIG. 1 merely indicates a locking mechanism 3, 4, consisting of a catch 3 and a pawl 4, in the relevant motor vehicle door latch 1. In addition, a sensor 5 is also shown, the exact function of which will be explained in more detail in the following. In fact, the sensor 5 that is connected to the control unit 2 in each case conveys the state of the relevant motor vehicle door latch or of an operating lever chain 12, 13, 14, which will be discussed in the following, in the sense of active/inactive.

In order to differentiate the individual motor vehicle door latches 1, said latches are in each case provided with subscript figures. Thus, the motor vehicle door latch 1 that is in or on the left-hand front side door, in the direction of travel F, is denoted 1₁. The motor vehicle door latch 1₂ is the motor vehicle door latch 1 associated with the right-hand front side door. Accordingly, the motor vehicle door latches 1₃ and 1₄ are associated with the left-hand rear and right-hand rear side door. In the example shown, all the motor vehicle door latches 1₁ to 1₄ communicate via a bus or, in general, one or more connection line(s) 6, with the superordinate control unit 2. The control unit 2 can be arranged in the inside of a motor vehicle body. Furthermore, the individual sensors 5 are connected to the control unit 2 by means of the connection line 6 or the bus, such that the sensor signals can be determined and evaluated by the control unit 2.

FIG. 2 shows the detailed structure of the relevant motor vehicle door latches 1. It can be seen that the relevant motor vehicle door latches 1₁ to 1₄ are in principle each designed in the same manner. In addition to the locking mechanism 3, 4, already discussed, consisting of a catch 3 and a pawl 4, it is firstly possible to identify an electromotive drive 8, 9, 10, 11.

In the present case, the electromotive drive 8 to 11 is equipped as an electromotive opening drive 8 to 11, and is acted on only in the event of external operation of an associated motor vehicle door (not shown explicitly). For this purpose, an outer door handle (not shown explicitly) may also be operated, which handle in turn triggers a sensor. The sensor signals thereof are evaluated by the control unit 2 and are interpreted as being associated with a desired external operation. As a result thereof, the control unit 2 acts on an electric motor 8 as a component of the electromotive opening drive 8 to 11.

By way of a screw located on the output shaft thereof, the electric motor 8 drives a screw wheel 9 which engages on a pin 11 of the pawl 4 by means of a contour 10 or an operating cam 10, and, in the event of an opening process of this kind, acts on the pawl 4 in the clockwise direction, indicated in FIG. 2. As a result, the catch 3 is released and can also release, in a spring-assisted manner, a locking pin (not shown). The catch 3 then opens in a spring-assisted manner, in the clockwise direction shown. In this way, the associated motor vehicle door can be opened from the outside.

As well as said electromotive opening drive 8 to 11 for the external operation or an electrical opening process from the outside, an operating lever chain 12, 13, 14 that acts mechanically on the locking mechanism 3, 4 is in addition also formed. In the exemplary embodiment, the operating lever chain 12, 13, 14 is designed as an internal operating lever chain 12, 13, 14. In fact, the operating lever chain or internal operating lever chain 12, 13, 14 comprises an inner door handle 12. In the case of pulling action, indicated in FIG. 2, the inner door handle 12 acts on an internal operating lever 13. If the internal operating lever 13 is mechanically coupled to the tripping lever 14, by means of a coupling 16, corresponding clockwise movements of the

L-shaped internal operating lever 13, which movements are indicated in FIG. 2, ensure that the tripping lever 14 is pivoted in the indicated anticlockwise direction, by means of the interposed coupling 16, and acts on a further pin 15 on the pawl 4. As a result, the pawl 4 is again raised out of the engagement thereof with the catch 3, and the motor vehicle door latch shown, as well as the associated motor vehicle door is opened. In contrast to the external operation using the electromotive opening drive 8 to 11, this corresponds to internal operation.

In the exemplary embodiment, the coupling 16 is a coupling pin 16 which can be changed, with respect to the position thereof inside a recess 18 of the internal operating lever 13, by means of a divided coupling lever or control lever 17. If the coupling pin 16 is in the position shown in dashed lines in FIG. 2, the overall operating lever chain 12, 13, 14 is closed, and, as described, action on the inner door handle 12 results in the locking mechanism 3, 4 being opened. The motor vehicle door latch 1 is unlocked.

If, in contrast, the coupling or the coupling pin 16 assumes the position also shown in FIG. 2, in dot-dashed lines, the internal operating lever 13 cannot act on the tripping lever 14, because the coupling or the coupling pin 16 then passes an associated edge 19 of the tripping lever 14, and the tripping lever 14 remains undisturbed. In this case, the locking mechanism 3, 4 cannot be opened. The motor vehicle door latch 1 is locked.

In order for it to be possible to implement and achieve the at least two positions indicated in FIG. 2, specifically “coupling engaged” (dashed) and “coupling disengaged” (dot-dashed), of the coupling or of the coupling pin 16, an electromotive drive 20 is implemented, by means of which the control lever or coupling lever 17 bearing the coupling pin 16 is acted on such that the coupling pin 16 assumes the desired position, at the end of the control lever 17. In this case, the coupling pin 16 is associated with the sensor 5, which has already been discussed. Therefore, by means of the sensor 5, the status of the operating lever chain 12, 13, 14 can be retrieved. If the “coupling engaged” position is assumed, then the operating lever chain 12, 13, 14 is in the “active” status. In contrast, the state “coupling disengaged” corresponds to the operating lever chain 12, 13, 14 assuming the “inactive” status thereof.

As already explained, the electromotive opening drive 8 to 11 is acted on only in the event of external operation of the associated motor vehicle door. The external operation can take place by means of the sensory query of the outer door handle (not shown). Alternatively or in addition, the external operation can, however, also take place by means of remote control and/or keylessly by means of an inquiry-response dialog, using a chipcard carried by the user, as is generally known. In contrast, the operating lever chain or internal operating lever chain 12, 13, 14 is acted on exclusively using the inner door handle 12.

The signal of the sensor 5 of the associated motor vehicle door latch 1 or the status of the corresponding operating lever chain 12, 13, 14 of the associated motor vehicle door latch 1 is transmitted to the control unit 2 in a door latch-specific manner. This is intended to be understood, according to the invention, to mean that the bus or the connection lines 6 transmit not only the signal of the sensor 5. Instead, the motor vehicle door latch 1 in question also transmits information about the associated motor vehicle door latch 1, to the control unit 2. The door latch-specific status that identifies the motor vehicle door latch 1, as well as the status of the operating lever chain 12, 13, 14 thereof, corresponds hereto. As a result thereof, for example information is transmitted to the control unit 2 such that the operating lever chain 12, 13, 14 has the status “inactive” for example in the right-hand front motor vehicle door latch 1₂. Comparable information is available from all the motor vehicle door latches 1₁ to 1₄.

In this manner, the control unit 2 can actuate some or all of the motor vehicle door latches 1₁ to 1₄ in a door latch-specific manner, depending on the functional position ultimately desired.

If for example the functional position “theft-proof” is desired, this corresponds to, firstly, all the electromotive opening drives 8 to 11 of the four relevant motor vehicle door latches 1₁ to 1₄ being switched to inactive. That is to say that the relevant electric motors 8 cannot be acted on by the control unit 2. As a result, external operation is not possible.

Furthermore, in this case the control unit 2 again actuates the electromotive drive 20 for actuating the coupling 16, which can be acted on electromotively, of all the motor vehicle door latches 1₁ to 1₄ such that said latches each transfer the associated operating lever chain 12, 13, 14 into the “inactive” state. In this “inactive” state, any operation of the inner door handle 12 also comes to nothing, and therefore the relevant motor vehicle door cannot be opened or unlocked either from the outside or from the inside. This is the conventional functionality in the “theft-proof” position.

If, in contrast, the “childproof” functional position is intended to be implemented, then the relevant electromotive opening drives 8 to 11 of all the motor vehicle door latches 1₁ to 1₄ continue to be held in the active position, by means of the control unit 2, because usually, “childproof” functional position, external unlocking and external opening of the relevant motor vehicle door should explicitly be possible, and is desired. In the same way, the operating lever chains 12, 13, 14 of the two motor vehicle door latches 1₁ and 1₂ associated with the front side doors are also transferred into the “active” position, unless they assume this functional position in any case. As a result, the two front side doors can also be opened from the inside in the “childproof” functional position.

In contrast, with respect to the motor vehicle door latches 1₃ and 1₄ associated with the rear side doors, the control unit 2 ensures that the electromotive drive 20 transfers the coupling 16, acted on thereby, into the “coupling not engaged” position, shown in dot-dashed lines in FIG. 2. As a result, the relevant operating lever chain or internal operating lever chain 12, 13, 14 has been transferred into the “inactive” state. Any action of the inner door handle 12 therefore come to nothing. However, if desired this applies only for the two rear side doors, and therefore overall this reproduces the “childproof” functional position.

1. A motor vehicle, comprising a plurality of motor vehicle door latches, as well as at least one control unit, each motor vehicle door latch comprising at least one operating lever chain that acts mechanically on a locking mechanism, the relevant status (active/inactive) of which chain is determined using a sensor and transmitted to the control unit, wherein the control unit distinguishes between individual functional positions, depending on the door latch-specific status of the operating lever chain.

2. The motor vehicle according to claim 1, wherein the operating lever chain is designed as an inner operating lever chain.

3. The motor vehicle according to either claim 1, wherein the operating lever chain is equipped with a coupling that can be acted upon electromotively in order to be able to achieve the relevant status (active/inactive).

4. The motor vehicle according to claim 1, wherein an electromotive drive that acts directly on the locking mechanism is provided.

5. The motor vehicle according to claim 4, wherein the electromotive drive, as an electromotive opening drive, is acted on only in the event of external operation of an associated motor vehicle door.

6. The motor vehicle according to claim 1, wherein the operating lever chain is acted on by means of an inner door handle.

7. The motor vehicle according to claim 1, wherein the external operation of the motor vehicle door latch is achieved by means of remote control and/or keylessly by means of a question/answer dialog, and/or by means of a sensory query of the outer door handle.

8. The motor vehicle according to claim 1, wherein the door latch-specific status operating lever chain contains information not only about the state of the operating lever chain (active/inactive), but rather also about the associated motor vehicle door latch.

9. The motor vehicle according to claim 8, wherein the door latch-specific status conveys information about the spatial/functional design of the relevant motor vehicle door latch, for example left-hand rear motor vehicle door latch.

10. The motor vehicle according to claim 1, wherein, depending on the desired functional position, the control unit actuates individual or all of the motor vehicle door latches in a door latch-specific manner.
